(19) United States
(12) Patent Application Publication
(10) Pub. No.: US 2023/0289737 A1
(43) Pub. Date: Sep. 14, 2023

(54) PROGRAM, INFORMATION PROCESSING APPARATUS, AND METHOD

(71) Applicant: Findy Inc., Tokyo (JP)

(72) Inventors: Masataka SATO, Tokyo (JP); Takashi UDAGAWA, Tokyo (JP); Kazuto OHARA, Tokyo (JP); Daishi MIYAMOTO, Tokyo (JP); Toshiaki YANAGISAWA, Tokyo (JP); Kihaya SUGIURA, Tokyo (JP); Yuki SHIGA, Tokyo (JP)

(73) Assignee: Findy Inc., Tokyo (JP)

(21) Appl. No.: 18/198,842

(22) Filed: May 18, 2023

Related U.S. Application Data
(63) Continuation of application No. PCT/JP2021/043149, filed on Nov. 25, 2021.

(30) Foreign Application Priority Data
Nov. 27, 2020 (JP) 2020-196963

(51) Int. Cl. G06Q 10/1053

(52) U.S. Cl. CPC G06Q 10/1053

(57) ABSTRACT

A server in an assumed annual income presentation system stores a user skill database for holding information of various parameters obtained by evaluating skills of each user as an engineer, and including, as its functions, a user job category reception module for receiving designation of a job category of a user who receives a presentation of an assumed annual income, and an assumed annual income specification module for specifying the assumed annual income for the user, based on the job category that has been designated by the user, a skill parameter related to the user, experience in the job category of each user, recruitment information of a company, or information of an annual income that has been received from each user, from the job category of the user.

### CROSS-REFERENCE TO RELATED APPLICATIONS

The present application is a bypass-continuation of PCT filing PCT/JP2021/043149, filed Nov. 25, 2021, which claims priority to JP 2020-196963, filed Nov. 27, 2020, the entire contents of each are incorporated herein by reference.

### FIELD

### Background

The present disclosure relates to a program, an information processing apparatus, and a method.

### Description of the Related Art

In recent years, job changes for the purpose of improving skills and increasing income have been becoming common. In particular, as for engineers, in order to improve their skills, they actively seek jobs and change jobs so that they can utilize their skills. In looking for a new job, it is necessary to appropriately evaluate and grasp engineer's own skills in order to find a company for which the engineer is going to work or in order to appeal to the company for which the engineer desires to work and to which the engineer has applied as the new job. Hence, various skill evaluation methods are provided.

Non Patent Literature 1 discloses a service for diagnosing the hourly wage as a service for freelance engineers. In this service, an assumed hourly wage is calculated, based on a score called a skill deviation value that has been calculated in accordance with the skills of each user, and is provided for the user.

In addition, Patent Literature 1 describes that information about documents, photographs, and programming languages is collected together with information for identifying a user (information such as a handle name, an identification number, an e-mail address, and a name) from an Internet site that an individual person has opened to the public on a network, such as a blog, a website, and a social network service (SNS). Patent Literature 1 describes that morphological analysis is conducted on these pieces of collected information to acquire an appearance frequency at which each word appears in the collected information, give an attribute to a user in accordance with the appearance frequency of a word, and give a numerical value (score) related to the attribute, based on a rule such as the appearance frequency of a word. In Patent Literature 1, examples of the score of the attribute given to the user include a score of an attribute related to a technical ability, a score of an attribute related to business, and the like.

### CITATION LIST

### Patent Literature

Patent Literature 1: JP 2020-091539 A

### Non Patent Literature

Non Patent Literature 1: “Automatically calculate engineer's hourly wage! Your market value can be estimated on GitHub!”, Findy blog, [searched on Nov. 10, 2020], the Internet <URL:https://findy-code.io/engineer-lab/new-release-hourly-wage>

### Technical Problems

### SUMMARY

In a business company, in proceeding with the development of a product, it is necessary to pay suitable rewards for personnel who possess necessary skills and provide opportunities to be active and successful. For this purpose, it is necessary to grasp suitable incomes of the personnel who possess skills.

On the other hand, as engineers, there is an issue that it is not easy to predict, by how to improve their own technical skills and careers, how they will have more opportunities to be active and successful and how their incomes will increase.

Therefore, in the present disclosure, a technique for predicting assumed incomes of engineers and objectively and accurately presenting the assumed incomes to the engineers so as to further support career advances and improvements of the engineers.

### Solutions to the Problems

According to an embodiment of the present disclosure, a program to be executed by a computer including a processor and a storage unit is provided. The program causes the processor to execute: a step of acquiring a first parameter for evaluating a skill of a user as an engineer for either or both of a programming language that the user has use experience and a software framework that the user has the use experience; and a step of specifying an assumed income for the user, by using an income prediction model for predicting an income of the user, based on the first parameter of the user.

According to an embodiment of the present disclosure, a program to be executed by a computer including a processor and a storage unit is provided. The program causes the processor to execute: a step of acquiring a first parameter for evaluating a skill of a user as an engineer; a step of receiving career information about a career of the user as the engineer; and a step of specifying an assumed income for the user, by using an income prediction model for predicting an income of the user, based on the first parameter of the user and the career information of the user.

### Advantages

According to the present disclosure, the assumed income of the user is specified by use of an income prediction model for predicting the income of the user, based on the first parameter obtained by evaluating the skills of each user as an engineer. Therefore, it is possible to objectively and accurately present the assumed income to the engineer.

### BRIEF DESCRIPTION OF DRAWINGS

FIG. 1 is a diagram illustrating an overall configuration of an assumed annual income presentation system.

FIG. 2 is a block diagram illustrating a functional configuration of a terminal device, which constitutes the assumed annual income presentation system in a first embodiment.

FIG. 3 is a diagram illustrating a functional configuration of a server, which constitutes the assumed annual income presentation system in the first embodiment.

FIG. 4 is a diagram illustrating data structures of a repository database and a company recruitment database, which are stored in the server.

FIG. 5 is a diagram illustrating data structures of a user skill database and an income prediction model database, which are stored in the server.

FIG. 6 is a flowchart illustrating an example of a flow of performing scoring processing by the assumed annual income presentation system in the first embodiment.

FIG. 7 is a flowchart illustrating an example of a flow of performing acquisition processing of annual income information by the assumed annual income presentation system in the first embodiment.

FIG. 8 is a flowchart illustrating an example of a flow of performing presenting processing of the assumed annual income by the assumed annual income presentation system in the first embodiment.

FIG. 9 is a diagram illustrating an example of a sign-in screen to be displayed on the terminal device.

FIG. 10 is a diagram illustrating a screen example of a skill parameter and the assumed annual income to be displayed on the terminal device.

FIG. 11 is a diagram illustrating a functional configuration of a server, which constitutes an assumed annual income presentation system 1 in a second embodiment.

FIG. 12 is a diagram illustrating a screen example of a skill parameter, an assumed annual income, and a desired job category input field to be displayed on the terminal device.

FIG. 13 is a diagram illustrating a screen example of a result to be displayed on the terminal device, after the skill parameter, the assumed annual income, and the desired job category are input.

FIG. 14 is a diagram illustrating another screen example of the result to be displayed on the terminal device 10, after the skill parameter, the assumed annual income, and the desired job category are input.

FIG. 15 is a diagram illustrating a screen example of the skill parameter, the assumed annual income, and an analysis result to be displayed on a terminal device.

### DETAILED DESCRIPTION

Hereinafter, embodiments of the present disclosure will be described with reference to the drawings. In the following description, the same components are denoted by the same reference numerals. This applies to their names and functions. Therefore, their detailed descriptions will not be repeated.

<Overview>

Hereinafter, an assumed annual income presentation system according to the present disclosure will be described. Such an assumed annual income presentation system is a system for presenting an assumed annual income in accordance with the skills and experience of engineers. Here, the annual income denotes one aspect of income in the present disclosure. The income denotes a payment to be received by a user as an engineer. For example, in a case where the user is a company employee employed by a company or the like, the income denotes the amount of salary and bonus. In a case where the user is a self-employed worker, a so-called freelance engineer, the income denotes the reward to be paid. However, the income is not limited to a total amount of salary plus bonus or an annual income that is the total amount of rewards in one year, and the income is a concept including an hourly wage, a daily wage, a weekly wage, and a monthly wage. Hereinafter, in the present disclosure, the annual income will be used as an example of the income. In addition, in the present disclosure, an income to be specified includes not only a specific and concrete amount of money but also an income with a certain amount of money range. For example, as a user's income, not only specifying that and the annual income is seven million but also specifying that the annual income is seven million to eight million.

The assumed annual income presentation system according to the present disclosure receives, as information of a user as an engineer, a skill parameter (first parameter) that has been calculated in accordance with activity results of the user and career information that has been designated by the user. In addition, the assumed annual income presentation system accumulates, as a database, career information of the respective other users (in the past), information of an annual income for an offered job indicated in recruitment information of a company or information of the annual income that has been input from each user. The assumed annual income system specifies an assumed annual income of a user whose career information has been designated, based on these pieces of information.

In order to calculate a skill parameter, the assumed annual income presentation system according to the present disclosure accesses, as an example, GitHub (registered trademark), which is a software development platform, and acquires various parameters (second parameter) indicating achievements of the user as an engineer. GitHub serves as a source code hosting service, has a source code repository for version management of source codes, and manages a list of source codes at a certain point of time. In addition, GitHub has functions such as a push for uploading a source code that has been created and corrected in a local environment (local repository) of an engineer to a remote environment (remote repository), a pull request for giving a notification that the push has been made and requesting a review, a comment at the time of the review, and a merge for confirming a review result. Note that here, the source code denotes a concept including a programming language such as Python and a script language that is one type of a programming language such as JavaScript (registered trademark).

As the various parameters indicating the achievements of the user as an engineer, by acquiring values such as the number of lines in the source code on GitHub, the number of pushes, the number of pull requests, the number of reviews, and the number of comments that are managed on GitHub, and analyzing these values, it is considered that it is possible to estimate the achievements and skills as the engineer. For example, it is estimated that an engineer having a large number of created lines in the source code, the number of pushes, and the number of pull requests is an engineer who acts as a worker who actually creates and corrects the source code in many cases, and an engineer having a large number of reviews (the number of cases of reviews conducted in accordance with requests from other engineers) and comments is an engineer who acts as a manager for managing a development project in many cases. Then, it is considered that it is possible to estimate the skill as each role depending on the degree of these numbers.

Therefore, in the assumed annual income presentation system according to the present disclosure, values of various parameters on GitHub are acquired and analyzed, and a skill parameter obtained by evaluating the skills of a user as an engineer is calculated. An assumed annual income of the user is specified, based on such a skill parameter, the career information of the respective other users, the information of the recruitment information of the company or the information of the annual income that has been received from each user, from a job category of the user. With such a configuration, it becomes possible to present a more objective assumed annual income to the user.

Furthermore, from the career information of the respective other users and the recruitment information of the company, it becomes possible to grasp what kind of experience the users should have and improve their own skills in order to increase their assumed annual incomes. Hence, it becomes possible to present necessary actions, present such a job category, present more specific recruitment information, and post a message on a social networking service (SNS).

### First Embodiment

Hereinafter, the assumed annual income presentation system 1 will be described. In the following description, for example, when a terminal device 10 accesses a server 20, the server 20 makes a response with information for generating a screen on the terminal device 10. The terminal device 10 generates and displays the screen based on the information that has been received from the server 20.

<1 Overall Configuration of Assumed Annual Income Presentation System 1>

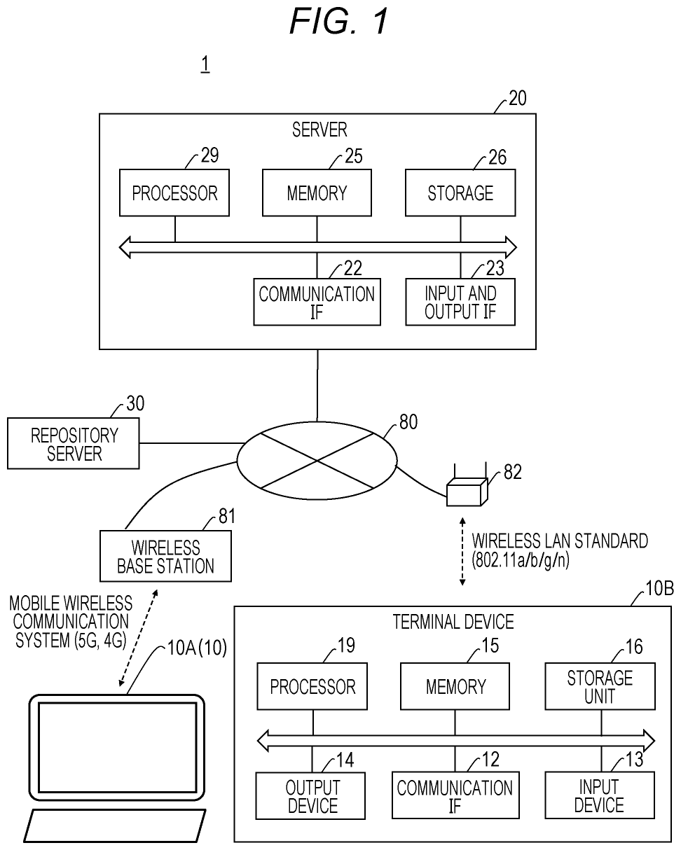

FIG. 1 is a diagram illustrating an overall configuration of the assumed annual income presentation system 1. As illustrated in FIG. 1, an assumed annual income presentation system 1 includes a plurality of terminal devices (a terminal device 10A and a terminal device 10B are illustrated in FIG. 1. Hereinafter, they will be collectively referred to as a “terminal device 10”, in some cases), the server 20, and a repository server 30. The terminal device 10, the server 20, and the repository server 30 are communicably connected with one another through a network 80. The network 80 is configured with a wired or wireless network.

The terminal device 10 is a device to be operated by each user. Here, a user denotes a person who uses the terminal device 10 and receives a presentation of the assumed annual income by the assumed annual income presentation system 1. However, it is configured such that the skill parameter of the user is calculated from various parameters on GitHub as described above, and thus the user denotes a person who is engaged in the source code development on GitHub. The terminal device 10 is implemented by a stationary personal computer (PC), a laptop PC, or the like. In addition to this, the terminal device 10 may be, for example, a portable terminal such as a tablet or a smartphone adaptive to a mobile communication system.

The terminal device 10 is communicably connected with the server 20 and the repository server 30 through the network 80. The terminal device 10 is connected with the network 80 by communicating with a communication device such as a wireless base station 81, which is compliant with a communication standard such as 4G, 5G, or long term evolution (LTE), or a wireless local area network (LAN) router 82, which is compliant with a wireless LAN standard such as Institute of Electrical and Electronics Engineers (IEEE) 802.11. As illustrated as the terminal device 10B in FIG. 1, the terminal device 10 includes a communication interface (IF) 12, an input device 13, an output device 14, a memory 15, a storage unit 16, and a processor 19.

The communication IF 12 is an interface for inputting and outputting signals so that the terminal device 10 communicates with an external device. The input device 13 is an input device (for example, a keyboard, a touch panel, a touch pad, a pointing device such as a mouse, or the like) for receiving an input operation from a user. The output device 14 is an output device (display, speaker, or the like) for presenting information to the user. The memory 15 is for temporarily storing programs, data processed by the programs, and the like, and is, for example, a volatile memory such as a dynamic random access memory (DRAM). The storage unit 16 is a storage device for storing data, and is, for example, a flash memory or a hard disc drive (HDD). The processor 19 is hardware for executing an instruction set written in a program, and includes an arithmetic operation device, a register, a peripheral circuit, and the like.

The server 20 is a device for managing various parameters on GitHub, a skill parameter of each user, information of job categories and annual incomes that has been received from general users, and recruitment information of companies. The server 20 receives career information from a user, specifies an assumed annual income of the user, and presents the information to the user.

The server 20 is a computer connected with the network 80. The server 20 includes a communication IF 22, an input and output IF 23, a memory 25, a storage 26, and a processor 29.

The communication IF 22 is an interface for inputting and outputting signals so that the server 20 communicates with an external device. The input and output IF 23 functions as an interface with an input device for receiving an input operation from the user and an output device for presenting information to the user. The memory 25 is for temporarily storing programs, data processed by the programs, and the like, and is, for example, a volatile memory such as a dynamic random access memory (DRAM). The storage 26 is a storage device for storing data, and is, for example, a flash memory or a hard disc drive (HDD). The processor 29 is hardware for executing an instruction set written in a program, and includes an arithmetic operation device, a register, a peripheral circuit, and the like.

The repository server 30 is a device for managing a remote repository on GitHub. The repository server 30 receives the source code that has been pushed by the user, stores and manages the source code, and receives a pull request, a comment, a merge, and the like.

<1.1 Configuration of Terminal Device 10>

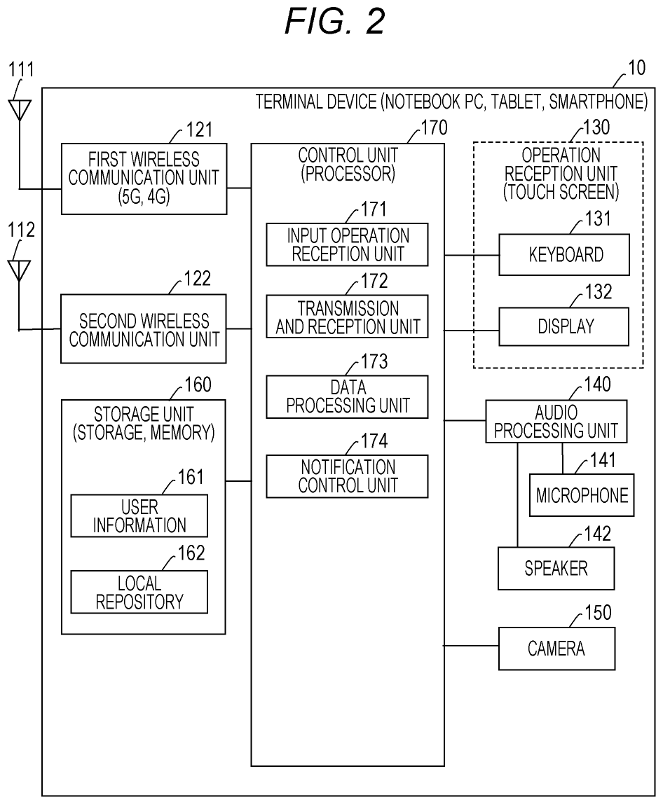

FIG. 2 is a block diagram illustrating a functional configuration of the terminal device 10, which constitutes the assumed annual income presentation system 1 in the first embodiment. As illustrated in FIG. 2, the terminal device 10 includes a plurality of antennas (an antenna 111 and an antenna 112), wireless communication units (a first wireless communication unit 121 and a second wireless communication unit 122) corresponding to the respective antennas, an operation reception unit 130 (including a keyboard 131 and a display 132), an audio processing unit 140, a microphone 141, a speaker 142, a camera 150, a storage unit 160, and a control unit 170. The terminal device 10 also has functions and configurations (for example, a battery for holding electric power, a power supply circuit for controlling the supply of the electric power from the battery to each circuit, and the like) that are not particularly illustrated in FIG. 2. As illustrated in FIG. 2, the respective blocks included in the terminal device 10 are electrically connected by a bus or the like.

The antenna 111 radiates signals emitted from the terminal device 10, as radio waves. In addition, the antenna 111 receives radio waves from space, and gives a reception signal to the first wireless communication unit 121.

The antenna 112 radiates signals emitted from the terminal device 10, as radio waves. In addition, the antenna 112 receives radio waves from space, and gives a reception signal to the second wireless communication unit 122.

The first wireless communication unit 121 performs modulation and demodulation processing and the like for transmitting and receiving signals via the antenna 111 so that the terminal device 10 communicates with another wireless device. The second wireless communication unit 122 performs modulation and demodulation processing and the like for transmitting and receiving signals via the antenna 112 so that the terminal device 10 communicates with another wireless device. The first wireless communication unit 121 and the second wireless communication unit 122 are each a communication module including a tuner, a received signal strength indicator (RSSI) calculation circuit, a cyclic redundancy check (CRC) calculation circuit, a high frequency circuit, and the like. The first wireless communication unit 121 and the second wireless communication unit 122 each conducts modulation or demodulation and frequency conversion of wireless signals transmitted and received by the terminal device 10, and give a reception signal to the control unit 170.

The operation reception unit 130 has a mechanism for receiving a user's input operation. Specifically, the operation reception unit 130 includes a keyboard 131 and a display 132. Note that the operation reception unit 130 may be configured as a touch screen that detects a contact position of the user on the touch panel, by using, for example, an electrostatic capacitive touch panel.

The keyboard 131 receives an input operation of the user of the terminal device 10. The keyboard 131 is a device that conducts a character input, and outputs character information that has been input, to the control unit 170, as an input signal.

The display 132 displays data such as an image, a video, and a text in accordance with the control of the control unit 170. The display 132 is implemented by, for example, a liquid crystal display (LCD) or an organic electro-luminescence (EL) display.

The audio processing unit 140 modulates and demodulates an audio signal. The audio processing unit 140 modulates a signal given from the microphone 141, and gives a modulated signal to the control unit 170. In addition, the audio processing unit 140 gives the audio signal to the speaker 142. The audio processing unit 140 is implemented by, for example, a processor for audio processing. The microphone 141 receives an audio input, and gives an audio signal corresponding to the audio input to the audio processing unit 140. The speaker 142 converts the audio signal given from the audio processing unit 140 into a sound, and outputs the sound to the outside of the terminal device 10.

The camera 150 is a device for receiving light with a light receiving element and outputting the light as a captured image. The camera 150 is, for example, a depth camera capable of detecting a distance from the camera 150 to an imaging target.

The storage unit 160 includes, for example, a flash memory or the like, and stores data and programs to be used by the terminal device 10. In one aspect, the storage unit 160 stores user information 161 and a local repository 162.

The user information 161 is information of a user who uses the terminal device 10, and who receives the presentation of an assumed annual income that is a function of the assumed annual income presentation system 1. The user information includes information for identifying a user (user ID), a user's name or a call name, organization information of a company or the like to which the user belongs, ID information and a password to sign-in to GitHub, and the like.

The local repository 162 stores information such as a source code for the user to work in his/her local environment in doing software development on GitHub. The user stores the created source code in the local repository 162, and corrects the source code stored in the local repository 162. After completion of creation and correction, the user pushes the source code to the repository server 30.

The control unit 170 reads a program stored in the storage unit 160, and executes commands included in the program so as to control the operation of the terminal device 10. The control unit 170 is, for example, an application installed in the terminal device 10 beforehand. The control unit 170 operates in accordance with the program, and fulfills functions as an input operation reception unit 171, a transmission and reception unit 172, a data processing unit 173, and a notification control unit 174.

The input operation reception unit 171 performs processing of receiving a user's input operation on an input device such as the keyboard 131.

The transmission and reception unit 172 performs processing for the terminal device 10 to transmit or receive data to or from an external device such as the server 20 in compliance with communication protocols.

The data processing unit 173 performs an arithmetic operation in accordance with a program on the data, the input of which has been received by the terminal device 10, and performs processing of outputting an arithmetic operation result to a memory or the like.

The notification control unit 174 performs processing of presenting information to the user. The notification control unit 174 performs processing of causing a display image to be displayed on the display 132, processing of causing the speaker 142 to output the sound, processing of causing the camera 150 to generate vibration, and the like.

<1.2 Functional Configuration of Server 20>

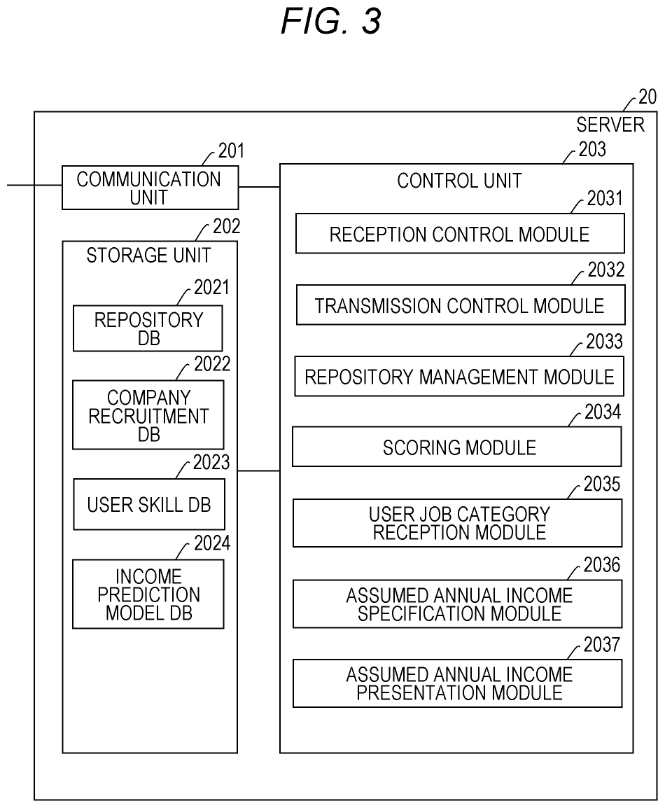

FIG. 3 is a diagram illustrating a functional configuration of the server 20, which constitutes the assumed annual income presentation system 1 in the first embodiment. As illustrated in FIG. 3, the server 20 fulfills functions as a communication unit 201, a storage unit 202, and a control unit 203.

The communication unit 201 performs processing for the server 20 to communicate with an external device.

The storage unit 202 stores data and programs to be used by the server 20. The storage unit 202 stores a repository database 2021, a company recruitment database 2022, a user skill database 2023, an income prediction model database 2024, and the like.

The repository database 2021 is a database for holding various types of information about various parameters, such as the number of lines in the source code and the number of pushes in the remote repository that have been acquired from the repository server 30, in the assumed annual income presentation system 1. Details will be described later.

The company recruitment database 2022 is a database for holding recruitment information from a company to be presented to a user in the assumed annual income presentation system 1. Details will be described later.

The user skill database 2023 is a database for holding information of various parameters that have been acquired from the repository server 30 in the assumed annual income presentation system 1 and that have been obtained by evaluating the skills of each user as an engineer. Details will be described later.

The income prediction model database 2024 is a database for holding information of an assumed annual income that has been calculated, based on information of an annual income for an offered job indicated in the recruitment information of a company or the annual income that has been input from each user, in the assumed annual income presentation system 1. Details will be described later.

The processor of the server 20 performs processing in accordance with a program, so that the control unit 203 fulfills functions illustrated in a reception control module 2031, a transmission control module 2032, a repository management module 2033, a scoring module 2034, a user job category reception module 2035, an assumed annual income specification module 2036, and an assumed annual income presentation module 2037, as various modules.

The reception control module 2031 controls processing for the server 20 to receive signals from an external device in compliance with communication protocols.

The transmission control module 2032 controls processing for the server 20 to transmit signals to an external device in compliance with communication protocols.

The repository management module 2033 controls processing of acquiring information about each user recorded on a network. A user of the assumed annual income presentation system 1 is engaged in the source code development on GitHub. Hence, various parameters (second parameter) such as the number of lines in the source code that have been created on GitHub, the number of pushes of the source code, the number of pull requests, the number of stars each indicating an evaluation from another member in the repository, and the number of followers are recorded in the repository server 30. Therefore, the repository management module 2033 acquires an ID and a password for accessing the repository server 30 from each user, accesses the repository server 30, and acquires the various parameters of the user.

In the repository server 30, in order to manage the version of the source code, when a certain user pushes the source code from the local repository, information of the user and the date and time at that time are recorded as log information. Similarly, in a case where a pull request is made for the source code, in a case where a comment is created, and in a case where there a merge is done, regarding the respective actions, information of a user who has taken such an action and its date and time have been recorded as log information. These pieces of information are recorded for every project to which each user belongs and for every file of the source code that has been created in the project. The repository management module 2033 acquires these pieces of log information from the repository server 30.

The scoring module 2034 controls processing of calculating a skill parameter (first parameter) that is a value obtained by evaluating the skills of each user as an engineer, based on the various parameters that have been acquired by the repository management module 2033. Here, the skill parameter denotes a value obtained by evaluating the skill necessary for every job category or years of experience in the job category of an individual engineer and converting it into a numerical value, and may be a numerical value in accordance with an absolute evaluation or a value in accordance with a relative evaluation among predetermined users. Furthermore, in a case of an IT engineer, a programming language and a software framework that the IT engineer has use experience, and experience periods (years) for each of them may be evaluated and converted into a numerical value. Here, the programming language denotes a language for use in software development, and specifically includes HTML, CSS, JavaScript, Java (registered trademark), Scala, PHP, Ruby, Python, Go, C #, Node.js, and the like. In addition, the software framework denotes a software platform for use in the software development, and specific examples include jQuery, React, Vue.js, Angular, Nuxt.js, Next.js, ReactNative, Spring Framework, Play Framework, Laravel, CakePHP, RubyonRails, Django, Flask, TensorFlow, gin, Unity, and Express.

For example, by counting the number of lines in the source code that have been created on GitHub and the number of pushes of the source code for a certain period of time, it is possible to learn about a period of time while the user, as an engineer, creates a certain amount of source code. Hence, it is possible to estimate the skill of the user as an engineer (programmer). For this reason, the scoring module 2034 acquires each parameter of each user from the various parameters that have been acquired by the repository management module 2033, and calculates the skill parameter, based on the viewpoint as described above. Such a skill parameter may be calculated for every programming language. In a case of a user having use experience of a plurality of programming languages, the skill parameter may be calculated for every programming language and for every software framework. Note that the skill of the user as an engineer (a team leader or a manager) may be estimated in accordance with the number of pull requests of which a notification has been given on GitHub, the number of reviews of the source code (the number of review cases in response to requests from other engineers), and the number of comments on the source code for a certain period of time. In calculating the skill parameter, for example, a learned model that has been subjected to machine learning so as to calculate the skill parameter from these various parameters (second parameter) is created beforehand, so that the skill parameter can be calculated by use of the learned model. Specifically, an example is a machine learning model (neural network, support vector regression (SVR), or the like) generated by performing machine learning by use of numerical values in a repository on GitHub as teacher data or performing learning such as deep learning or the like.

In addition, the skill parameter obtained by evaluating the technical ability of the user and calculated by the scoring module 2034 may be a parameter also including a business score and a dissemination ability score that are obtained by scoring a business ability, a dissemination ability, and the like. For example, in cooperation with an SNS used by the user, the business score and the dissemination ability score may be calculated as the business ability or the dissemination ability from a self-introducing message on the SNS, the number of followers, the number of comments on a message on the SNS, and the like, and may be included in the first parameter. The business score denotes a numerical value obtained by converting, for example, the user's skills about attributes required for business, such as company management, leadership, accounting, and the like. The dissemination ability score denotes a numerical value obtained by converting, for example, the user's skills about attributes related to actively delivering information to the outside or influencing on other users, such as a large number of pieces of information disclosed on the Internet, a large number of readers, a large number of evaluations from other users, and the like. Specifically, the business score may be calculated from the self-introducing message on the SNS and pieces of information of a job category and an experience period of time to be described later, and the dissemination ability score may be calculated from the number of messages on the SNS, the number of followers, and the number of comments on the messages on the SNS. Furthermore, the dissemination ability score may be calculated from the number of slides and the number of downloads from a disclosed service in a slide show or the like, and the number of reactions of others to the messages on the SNS (the obtained number of “likes”). The evaluation of an individual engineer may be conducted as an absolute value from a viewpoint of the technical ability, the business ability, and the dissemination ability, or may be converted into a numerical value as a relative evaluation in comparison with the evaluations of other users, or predetermined weighting may be given to each value of the technical ability, the business ability, and the dissemination ability.

The user job category reception module 2035 controls processing of receiving designation of a job category as career information of a user who receives the presentation of an assumed annual income by the assumed annual income presentation system 1. The job category of the user is not merely based on a classification in accordance with a type of employment such as “company employee” or “engineer”, but is based on a classification that clarifies a specific business content, a work content, or a role. Examples include “front-end engineer”, “AI programmer”, and the like, as a specific job category of a software engineer. Note that the user job category reception module 2035 may receive, as a designated job category, information of the job category that has been designated by the user when registering the information in the assumed annual income presentation system 1. In addition, together with the designation of the job category of the user, the user job category reception module 2035 may receive a belonging period of time (working period of time) in such a job category, a vacant (blank) period at the present time in a case where the user does not work in such a job category at the present time, and an annual income at the present time. These input values are used in an assumed annual income specification module 2036, as will be described below. Furthermore, the user job category reception module 2035 may acquire, as the career information of each user, information about the skills of each user, for example, information about a use experience period of a programming language, a use experience period of a software framework, and the like. Furthermore, the user job category reception module 2035 may acquire, as the career information of each user, information about the user on an open source that is recorded on a network for each user, for example, information indicating that a certain evaluation has been obtained by posting messages on open source software (OSS). The information indicating that the certain evaluation is obtained on the OSS may be, for example, an evaluation value by an objective evaluation model such as an open source maturity model (OSMM) or an open business quality rating (OpenBQR), or may be an evaluation by a comment from another person or the like.

As described above, the career information is a concept including not only the experience relate to a job category as an engineer, specifically, information of experience of “front-end engineer”, “AI programmer”, and the like but also information of management experience of managing a team to proceed with a project in the team, information of experience of negotiation with a customer (with a customer or an upper-level manager in the company), and information of experience of determining a requirement definition as higher-level skills of an engineer. The information of the management experience specifically denotes information indicating a business title of the user or a role of the user in the project, such as a description of “Go manager”, “CTO”, or the like. Furthermore, the career information is a concept including information of experience regarding skills as an engineer, specifically, experience of a programming language and a software framework. Furthermore, the concept includes information about the user on an open source that is recorded on a network.

The assumed annual income specification module 2036 controls processing of specifying an assumed annual income of a user, by using an income prediction model, from the career information that has been designated by the user by the user job category reception module 2035, the skill parameter of the user that has been calculated by the scoring module 2034, and the job category of the user. In the assumed annual income presentation system 1, as the career information of the user that has been received by the user job category reception module 2035, information indicating a relationship between the experience in the job category of each user and the annual income of the user having its experience is stored as the income prediction model by use of the information of the belonging period in the job category and the annual income at that time, information of a belonging period in the job category of a general user (who will not receive the presentation of the assumed annual income presentation system 1) and the annual income at that time, recruitment information of a company, and the like. In addition, the skill parameter for the experience in the job category of each user is calculated. However, the assumed annual income specification module 2036 does not necessarily acquire these pieces of information as the information stored in the storage unit 202 to specify the annual income, and may specify the annual income by using the income prediction model. Note that the information of the belonging period in the job category of the general user and the annual income at that time may be self-reported information, or may be objective data that has been acquired in another method. The assumed annual income specification module 2036 specifies an assumed annual income of the user, based on a relationship between a skill parameter that has been calculated from the experience in the job category of each user and the annual income of a user having such a skill parameter. In addition, the annual income may be specified, based on the programming language, the software framework, and the like that the user has experience, in relation to the information of the job category. Furthermore, the annual income may be specified for every programming language. In a case of a user who has use experience of a plurality of programming languages and whose skill parameters have been calculated for a plurality of programming languages, the annual income may be specified in a comprehensive manner, based on these skill parameters.

Furthermore, the assumed annual income specification module 2036 may specify an assumed annual income of each user, based on the skill parameter of each user, information of a job category that is a precondition of the skill (such as the “front-end engineer” as described above), and information of an experience period (years) in the job category. This is because it is difficult to recognize the skill without certain years of experience in some cases, and the annual income differs in many cases. Furthermore, the assumed annual income specification module 2036 may specify an assumed annual income of each user, based on the information of the skills that each user possesses (self-recommended skill) as the career information. Regarding the self-recommended skill of the user, it is possible to estimate from, for example, the description about the skill that has been acquired from the user by the user job category reception module 2035 or the information of a posted message on an SNS or an OSS. For example, the assumed annual income specification module 2036 estimates the number of so-called “likes” for the posted message on the SNS, information indicating that the user has obtained a certain evaluation on the OSS as described above, and a predetermined keyword (a specific name of the programming language, the software framework, or the like) included in the content of the posted message on the SNS.

As a specific example, the assumed annual income specification module 2036 first specifies an assumed annual income of the user, based on the skill parameter of the user. Next, weighting (for example, addition by multiplication by a certain percentage) is given in accordance with the job category and the years of experience of the user, so that an addition is given to the annual income. At this timing, in a case where the user has management experience or the like that is a higher-level skill of an engineer as the career information of the user, different weighting may be given (for example, another addition is given to the annual income). Furthermore, weighting (for example, addition by multiplication by a certain percentage) is given in accordance with the self-recommended skill of the user, so that an addition is given to the annual income. In this manner, regarding the user, the assumed annual income is specified, based on the skill parameter, the job category, the years of experience, and the self-recommended skill. Note that the weighting in accordance with the job category and the years of experience of the user and the weighting in accordance with the self-recommended skill of the user may be not only weighting for giving an addition to the annual income (for example, multiplication by a value larger than 1) but also weighting for subtracting from the annual income (for example, multiplication by a value smaller than 1). In the assumed annual income specification module 2036, such an annual income may be specified beforehand and stored in the user skill database 2023. Furthermore, as described above, the annual income prediction that is based on the business score or the dissemination ability score (at least one of them) may be conducted by giving weighting or the like including not only the skill parameter but also the business score or the dissemination ability score.

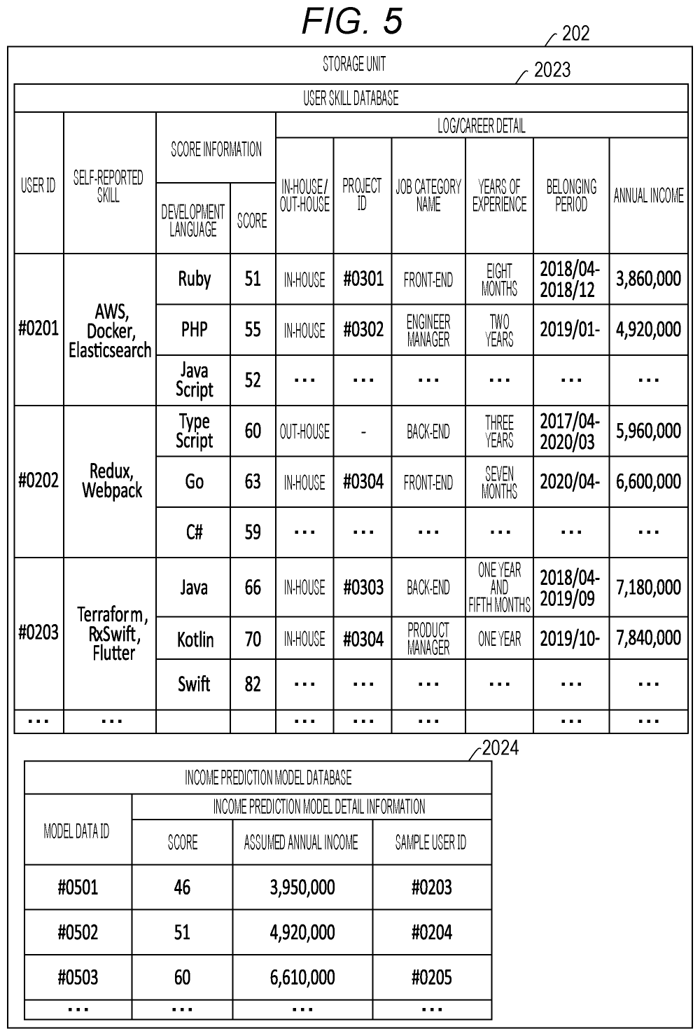

The income prediction model to be referred to by the assumed annual income specification module 2036 indicates the relationship between the experience in the job category of each user and the annual income of the user having such experience, and may include statistical data indicating a minimum value and a maximum value of the annual income that have been aggregated for every skill parameter that has been calculated from the experience (years) in the job category of each user, or may indicate an average value, a median value, a most frequent value, or the like. For example, the assumed annual income specification module 2036 may specify an assumed annual income of the user by using a database storing these pieces of information as a correspondence table, or may specify the assumed annual income of the user from a machine learning model that has performed machine learning by using these pieces of information as teacher data. That is, the income prediction model for predicting an income from the skill parameter and the career information of the user is created beforehand, and the income is predicted by use of the income prediction model. As the income prediction model, the machine learning is performed with the teacher data including a database as illustrated in FIG. 5 to be described later, a correspondence table or a function indicating a relationship between experience in a job category of each user and an annual income of a user having such experience, and information of the experience in the job category of each user and the annual income of the user having such experience. Alternatively, a machine learning model (neural network, support vector regression (SVR), or the like) to be generated by performing the learning such as deep learning can be used.

In a case where there are a plurality of job categories that have been designated by the user, the assumed annual income specification module 2036 may receive a belonging period (working period) in every job category and specify the assumed annual income for the user with priority given to the job category of the user having a long experience period (years). In addition, designation of the job category with which the annual income is to be specified may be received from the user.

The assumed annual income presentation module 2037 controls processing of presenting, to the user, information of the annual income that has been specified by the assumed annual income specification module 2036. The assumed annual income presentation module 2037 transmits the information of the specified annual income to the terminal device 10 of the user via the communication unit 201.

<2 Data Structure>

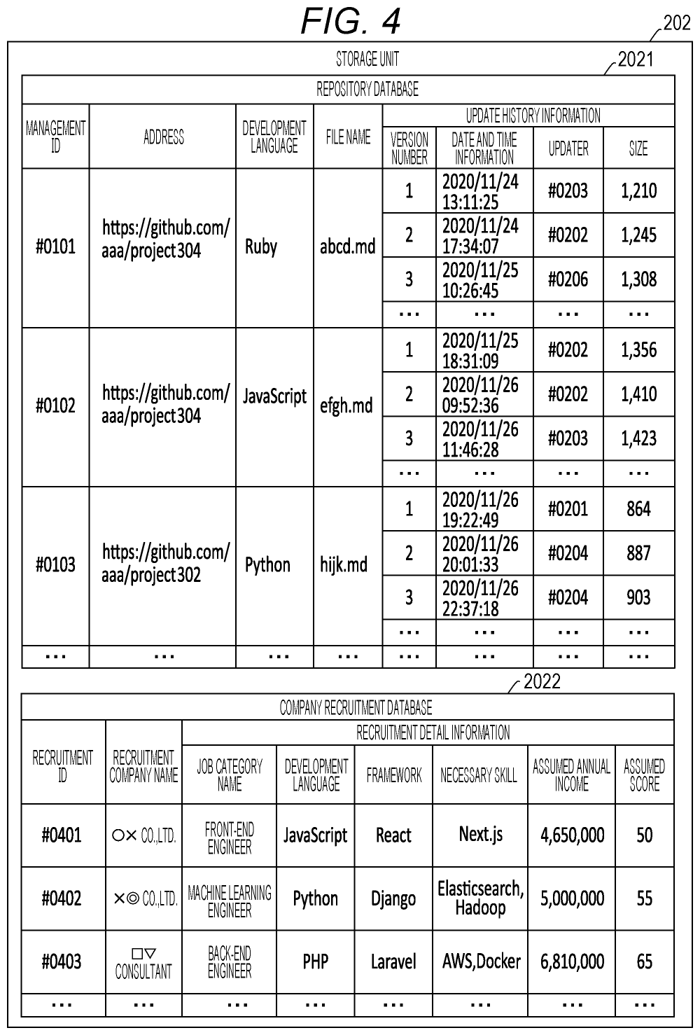

FIG. 4 is a diagram illustrating data structures of the repository database 2021 and the company recruitment database 2022, which are stored in the server 20. In addition, FIG. 5 is a diagram illustrating data structures of the user skill database 2023 and the income prediction model database 2024, which are stored in the server 20.

As illustrated in FIG. 4, each record in the repository database 2021 includes an item “management ID”, an item “address”, an item “development language”, an item “file name”, an item “update history information”, and the like.

The item “management ID” denotes information for identifying each file of the source code in the repository server 30, from which various parameters are acquired in the assumed annual income presentation system 1.

The item “address” denotes information indicating an address (URL) of the repository server 30, from which the various parameters are acquired in the assumed annual income presentation system 1, and stores an address of a remote repository that has been created for every project. With this address, it becomes possible to identify a file name (README.txt or the like) common to every project.

The item “development language” denotes information of a programming language for use in the project in the repository server 30, from which the various parameters are acquired in the assumed annual income presentation system 1.

The item “file name” denotes information of a file name of the source code that is pushed to the repository server 30, from which the various parameters are acquired in the assumed annual income presentation system 1.

The item “update history information” denotes information about an update history of the source code that is pushed to the repository server 30, from which the various parameters are acquired in the assumed annual income presentation system 1, and specifically includes an item “edition number”, an item “date and time information”, an item “updater”, an item “size”, and the like. The item “update history information” denotes version management information of the source code on GitHub.

The item “version number” denotes information of a version number of the file (version number) of the source code that is pushed to the repository server 30, and is counted up, for example, whenever the source code is updated.

The item “date and time information” denotes information of the date and time when the file of the source code that is pushed to the repository server 30 is updated (merged) to such a version.

The item “updater” denotes information for identifying each user who has updated the file of the source code that is pushed to the repository server 30 to such a version.

The item “size” denotes information indicating a file size of the source code in such a version that is pushed to the repository server 30.

The repository management module 2033 of the server 20 updates the repository database 2021 in accordance with acquisition of log information from the repository server 30.

Each record of the company recruitment database 2022 includes an item “recruitment ID”, an item “recruitment company name”, an item “recruitment detail information”, and the like.

The item “recruitment ID” is information for identifying each piece of recruitment information of a company to be presented to the user in the assumed annual income presentation system 1.

The item “recruitment company name” is information indicating the name of a company that is offering recruitment information to be presented to the user in the assumed annual income presentation system 1. Note that not only the name of the company but also a department name or the like may be included.

The item “recruitment detail information” is information related to the recruitment information to be presented to the user from the assumed annual income presentation system 1, and specifically includes an item “job category name”, an item “development language”, an item “framework”, an item “necessary skill”, an item “assumed annual income”, an item “assumed score”, and the like.

The item “job category name” is information indicating the name of a job category in the recruitment information to be presented to the user, and may store a job category name such as “IT engineer”, or may store a specific name of work in charge as illustrated in FIG. 4.

The item “development language” is information of a programming language for use in the work in the recruitment information.

The item “framework” is information of a software framework for use in the work in the recruitment information.

The item “necessary skill” is information about the (essential) skill required for the work in the recruitment information.

The item “assumed annual income” is information indicating an assumed annual income (to be paid by the company) in a case where the user is employed in accordance with the recruitment information that is presented to the user, and is the total amount of salary plus bonus to be paid in one year in a case where the user is employed by the company or the total amount of rewards to be paid in one year in a case where the user is subcontracted as a self-employed worker.

The item “assumed score” is information indicating a score (value) of the skill parameter desired by an employer in the recruitment information to be presented to the user.

As illustrated in FIG. 5, each record in the user skill database 2023 includes an item “user ID”, an item “self-reported skill”, an item “score information”, an item “log/career detail”, and the like.

The item “user ID” is information for identifying each user who receives the presentation of the annual income that has been specified in the assumed annual income presentation system 1, and corresponds to the item “updater” of the repository database 2021.

The item “self skill information” is information indicating the skill information of the user that has been input by the user who receives the presentation of the annual income that has been specified in the assumed annual income presentation system 1.

The item “score information” is score information of the user who receives the presentation of the annual income that has been specified in the assumed annual income presentation system 1, and specifically includes an item “development language”, an item “score”, and the like.

The item “development language” is information of a programming language that the user has experience, and the user receives the presentation of the annual income that has been specified in the assumed annual income presentation system 1.

The item “score” is information indicating a skill parameter of the user who receives the presentation of the annual income that has been specified in the assumed annual income presentation system 1, and is a value that has been calculated by the scoring module 2034. As illustrated in FIG. 5, the score is calculated for every item “development language”.

The item “log/career detail” is information about a job category in the past that has been acquired from various parameters of log information on GitHub of the user who receives the presentation of the annual income that has been specified in the assumed annual income presentation system 1, and information about a job category in the past by self-report or the like, and specifically includes an item “in-house/out-house”, an item “project ID”, an item “job category name”, an item “years of experience”, an item “belonging period”, an item “annual income”, and the like.

The item “in-house/out-house” is information indicating whether the career relates to a current belonging company (in-house) or does not relate to the current belonging company (out-house) in the past or current job category of the user.

The item “project ID” is information for identifying each project in the belonging company in the past or current job category of the user.

The item “job category name” is information indicating the name in the past or current job category of the user.

The item “years of experience” is information indicating a period of time while the user has experience in the past or current job category, and for example, information of the number of months or years is stored.

The item “belonging period” is information indicating a belonging period of time of the user in the past or current job category and information for grasping the timing and period while the user has been engaged in the job category.

The item “annual income” is information of the annual income of the user in the past or current job category, and is the total amount of salary plus bonus that has been paid in one year in a case where the user has been employed by the company, and is the total amount of rewards that has been paid in one year in a case where the user has gone subcontracted as a self-employed worker.

Various parameters such as the number of created lines in the source code on GitHub, the number of pushes of the source code, the number of pull requests, the number of reviews, and the number of comments may be stored in the records of the user skill database 2023.

The scoring module 2034 of the server 20 updates the user skill database 2023 in accordance with calculation of the skill parameter of each user.

Each record in the income prediction model database 2024 includes an item “model data ID”, an item “income prediction model detail information”, and the like.

The item “model data ID” is information for identifying each piece of model data indicating a relationship between experience in a job category of each user and a skill parameter as well as an annual income of the user having such experience that have been collected in the assumed annual income presentation system 1.

The item “income prediction model detail information” is model data indicating a relationship between the experience in the job category of each user and the skill parameter as well as the annual income of the user having such experience that have been collected in the assumed annual income presentation system 1, and specifically includes an item “score”, an item “assumed annual income”, an item “sample user ID”, and the like. Note that it may be configured to accumulate the information of the skill parameter and the annual income of the user stored in the item “income prediction model detail information”, only in a case where the user's approval has been obtained, and it may be configured to store only the latest information of the user. The user's approval may be obtained, for example, by defining the supply of data in the terms of use and obtaining the user's agreement with the terms of use beforehand.

The item “score” is information indicating the skill parameter of each user having experience in the job category, and is a value calculated by the scoring module 2034.

The item “assumed annual income” is information indicating an annual income of each user who has experience in the job category, and is a value specified by the assumed annual income specification module 2036.

The item “sample user ID” is information for identifying each user who has experience in the job category, and corresponds to the item “updater” of the repository database 2021.

<3 Operation>

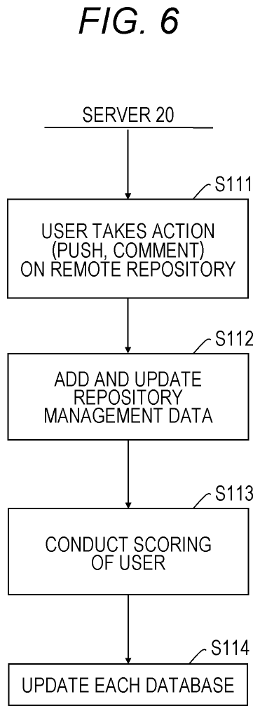

Hereinafter, referring to FIGS. 6 to 8, scoring processing, acquisition processing of annual income information, and presentation processing of an assumed annual income in the assumed annual income presentation system 1 in the first embodiment will be described.

FIG. 6 is a flowchart illustrating an example of a flow of performing the scoring processing by the assumed annual income presentation system 1 in the first embodiment.

In step S111, a user operates the terminal device 10 to take an action such as a push or a comment from the local repository to the remote repository in the repository server 30, and then the input operation reception unit 171 of the terminal device 10 receives an instruction for the action from the user. The transmission and reception unit 172 transmits information of the action that has been received to the server 20. The server 20 receives information of the action via the communication unit 201.

In step S112, the repository management module 2033 of the server 20 accesses the repository server 30 to transmit a request signal for information of various parameters (second parameter) such as the number of pushes of the source code and the number of pull requests in the source code of each user that are recorded in the repository server 30. The repository management module 2033 acquires information of various parameters from the repository server 30 via the communication unit 201, and stores the information of various parameters in the repository database 2021.

In step S113, the scoring module 2034 of the server 20 acquires parameters of each user in every job category and in every project, including the job category and the belonging period in the project, based on the various parameters acquired in step S112, and calculates a skill parameter (first parameter) that is a value obtained by evaluating the skills of each user as an engineer.

In step S114, the scoring module 2034 of the server 20 stores the skill parameter calculated in step S113 and the information of the various parameters to serve as bases in the user skill database 2023.

As described above, in the assumed annual income presentation system 1, the skill parameter (first parameter) is calculated, based on the various parameters that are pieces of the log information of the product on GitHub. Accordingly, it is possible to evaluate the product of the user from an objective viewpoint.

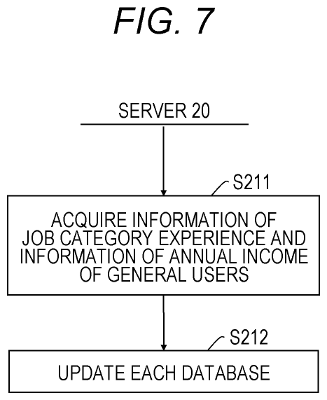

FIG. 7 is a flowchart illustrating an example of a flow of performing the acquisition processing of annual income information by the assumed annual income presentation system 1 in the first embodiment.

In step S211, the user job category reception module 2035 of the server 20 receives inputs of information about a belonging period in a job category of a general user and an annual income at that time via the communication unit 201. The general user denotes, for example, a general user who does not receive the presentation of the assumed annual income by the assumed annual income presentation system 1.

In step S212, the user job category reception module 2035 of the server 20 stores the information about the belonging period in the job category of the user and the annual income at that time received in step S211, in the income prediction model database 2024.

As described above, in the assumed annual income presentation system 1, it is possible to acquire information of the experience in the job categories of the respective other users and the annual incomes received from the respective users to serve as bases for specifying an assumed annual income. Then, from these pieces of information, it becomes possible to create the income prediction model for predicting the user's income beforehand.

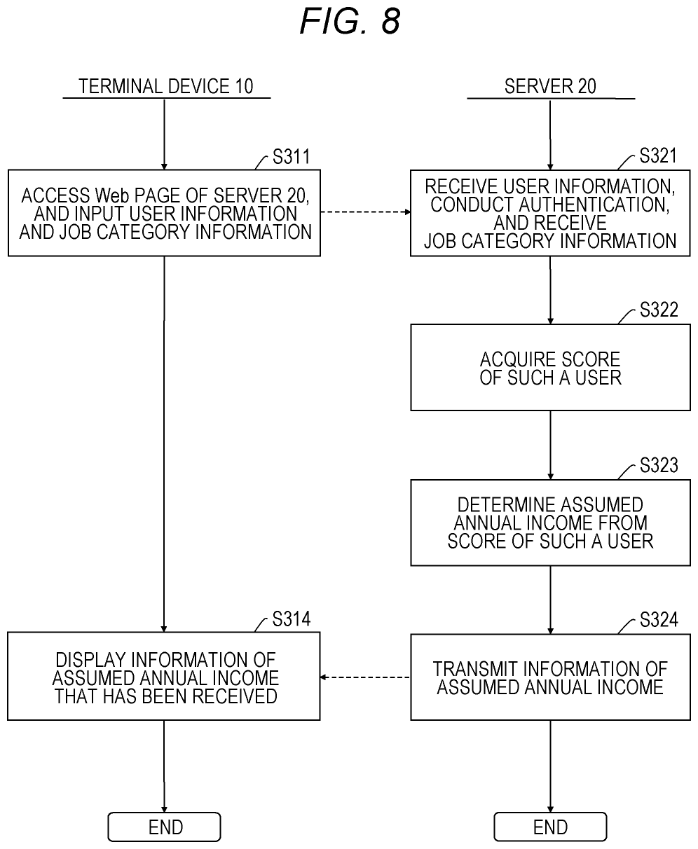

FIG. 8 is a flowchart illustrating an example of a flow of performing the presenting processing of the assumed annual income by the assumed annual income presentation system 1 in the first embodiment.

In step S311, the input operation reception unit 171 of the terminal device 10 receives, from the user, inputs of a user ID and a password to sign-in to the assumed annual income presentation system 1, and career information of the user. The transmission and reception unit 172 transmits the received user ID and password and the career information of the user to the server 20.

In step S321, the server 20 receives the user ID and the password via the communication unit 201, conducts predetermined authentication, and accepts the sign-in of the user. The repository management module 2033 of the server 20 receives the career information of the user via the communication unit 201.

In step S322, the assumed annual income specification module 2036 of the server 20 reads and acquires the skill parameter of the user calculated in step S113 from the user skill database 2023. Note that in acquiring the skill parameter, the latest skill parameter of the user may be calculated and acquired.

In step S323, from the career information of the user received in step S321 and the skill parameter related to the user calculated in step S322, the assumed annual income specification module 2036 of the server 20 specifies an assumed annual income of the user, based on the income prediction model stored in the income prediction model database 2024. In this situation, in a case where there are a plurality of job categories as the career information that has been designated by the user, the belonging period (working period) in the job category may be received for every job category, and the assumed annual income of the user may be specified with priority given to the job category of the user having a long experience period (years).

In step S324, the assumed annual income presentation module 2037 of the server 20 transmits information of the annual income specified in step S323 to the terminal device 10 via the communication unit 201 in order to present the information to the user.

In step S314, the transmission and reception unit 172 of the terminal device 10 receives information about the assumed annual income of the user that has been transmitted from the server 20. The notification control unit 174 causes the display 132 to display the information of the assumed annual income of the user that has been received.

As described above, by using the income prediction model, the assumed annual income presentation system 1 specifies the annual income of the user from the skill parameter that has been calculated, based on the various parameters that are pieces of the log information of products on GitHub, and the career information of the user. Accordingly, it becomes possible to specify the assumed annual income for the products of the user from an objective viewpoint.

<4 Screen Example>

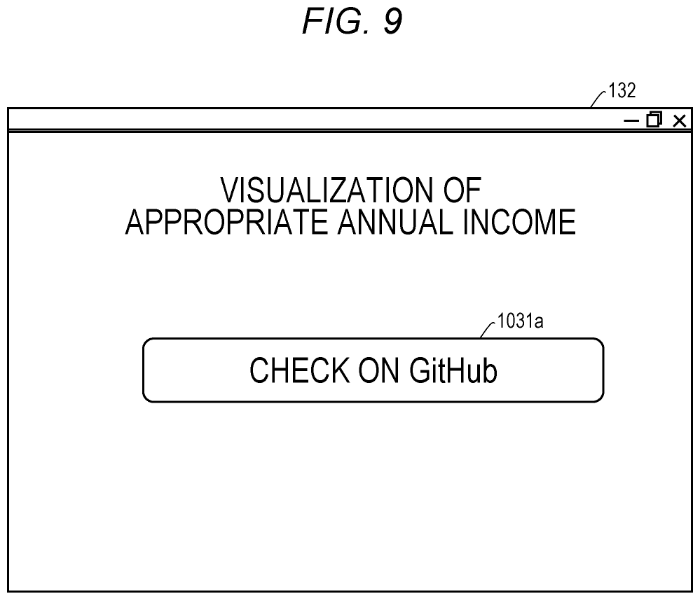

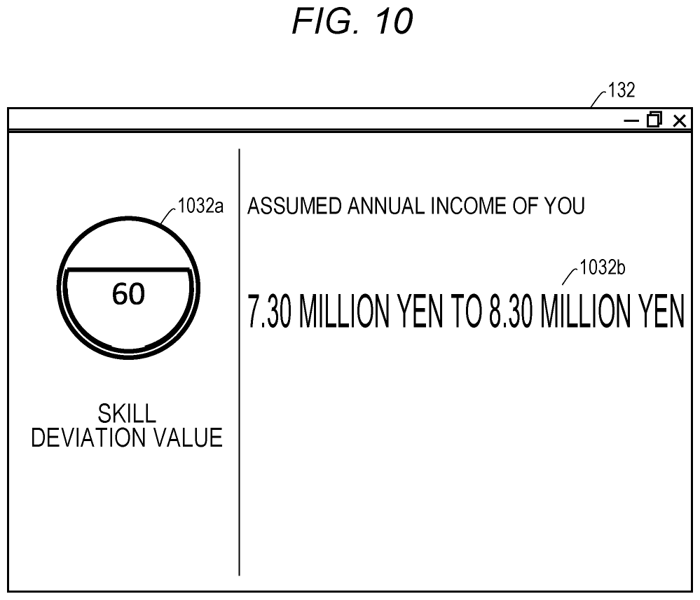

Hereinafter, referring to FIGS. 9 and 10, a screen example of the presentation processing of the assumed annual income by the assumed annual income presentation system 1 will be described.

FIG. 9 is a diagram illustrating an example of a sign-in screen to be displayed on the terminal device 10. The screen example of FIG. 9 illustrates a screen example, when a user who is going to receive the presentation of the assumed annual income signs in to the assumed annual income presentation system 1. This step corresponds to step S311 in FIG. 8.

As illustrated in FIG. 9, a screen transition button 1031a for receiving the presentation of the assumed annual income on GitHub is arranged on the display 132 of the terminal device 10. The screen transition button 1031a is a button for transitioning to a screen for accessing the repository server 30 (GitHub), and indicates that the assumed annual income is specified for the user, based on various parameters on GitHub.

The user presses the screen transition button 1031a, and then the screen transitions to a screen for inputting a user ID and a password for accessing the repository server 30 (GitHub). By inputting the user ID and the password, the user signs in to the repository server 30 (GitHub).

FIG. 10 is a diagram illustrating a screen example of a skill parameter and an assumed annual income to be displayed on the terminal device 10. The screen example of FIG. 10 illustrates a screen example in a state of displaying the skill parameter and the assumed annual income that has been specified, based on the skill parameter. This step corresponds to step S314 in FIG. 8.

As illustrated in FIG. 10, in response to an instruction operation for calculating an assumed annual income of the user, the display 132 of the terminal device 10 displays a skill parameter display field 1032a for displaying a skill parameter that is a value obtained by evaluating the skills of each user as an engineer, and an assumed annual income display field 1032b for displaying an assumed annual income that has been specified for the user. With such a value in the assumed annual income display field 1032b, the user is able to grasp his/her assumed annual income.

<Summary>

As described heretofore, according to the present embodiment, the skill parameter (first parameter) obtained by evaluating the skills of each user as an engineer is calculated, based on the various parameters of products in information recorded on a network, for example, GitHub. The annual income of the user is specified, based on this value and the experience in the job category (career information) of each user, by use of the income prediction model. Accordingly, it becomes possible to accurately specify the assumed annual income from an objective viewpoint, in consideration of the user's products and experience in the job category.

In addition, the annual income of the user is specified, based on the skill parameter (first parameter) that has been calculated for every programming language and every software framework. Regarding software engineers, an assumed income changes depending on which programming language and software framework abilities the user possesses. Therefore, it becomes possible to accurately specify an assumed annual income from an objective viewpoint for skills related to a specific programming language and software framework that the user possesses. Accordingly, the career of the user who is an engineer is properly evaluated, and thus it is possible to consider as a guideline of his/her own career.

### Second Embodiment

Hereinafter, another embodiment of the assumed annual income presentation system 1 will be described.

<1 Overall Configuration of Assumed Annual Income Presentation System 1>

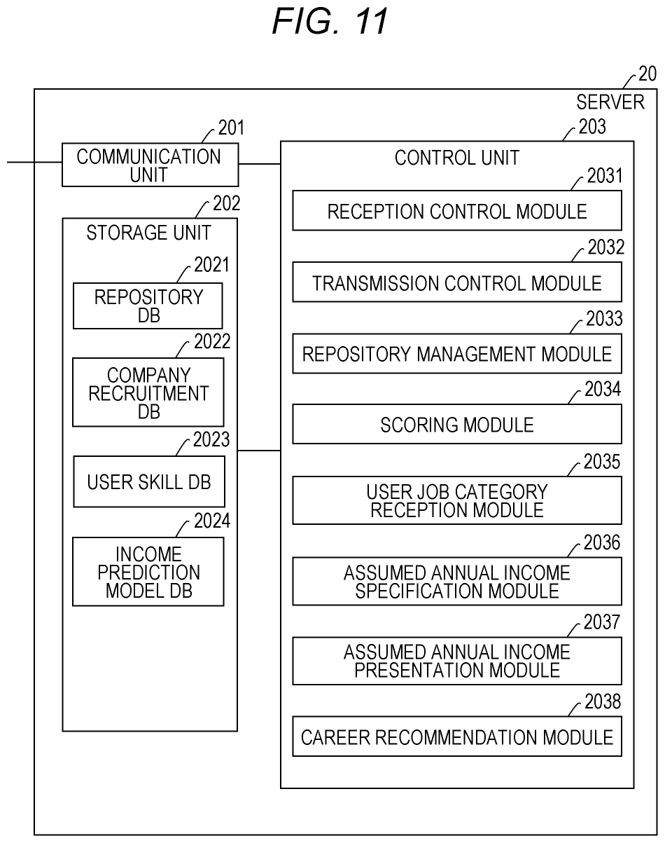

FIG. 11 is a diagram illustrating a functional configuration of a server 20, which constitutes an assumed annual income presentation system 1 in a second embodiment. The entire configuration of the assumed annual income presentation system 1 and the configuration of a terminal device 10 in the second embodiment are similar to those in the first embodiment, and they will not be described again. As illustrated in FIG. 11, the configuration of the server 20 is similar to that of the first embodiment except that a function of a career recommendation module 2038 is newly provided. Hereinafter, the function of the career recommendation module 2038 in the second embodiment will be described.

The career recommendation module 2038 controls processing of specifying a skill parameter or information about experience in a job category necessary for a user to whom the assumed annual income that has been presented by the assumed annual income presentation module 2037 so that an annual income becomes different from the specified annual income, and presenting (recommending) the specified skill parameter or information to the user. In this situation, the career recommendation module 2038 analyzes various parameters stored in the user skill database 2023, outputs an analysis result, and makes a recommendation, based on the analysis result.

For example, in a case where the user desires to have a different annual income, specifically, desires to increase the annual income, if the user is able to increase the skill parameter, it is considered that the assumed annual income also increases. Therefore, the career recommendation module 2038 specifies an action necessary for the user, specifically, an action that is enough to increase various parameters on GitHub, based on the experience in the job category of the respective other users, recruitment information of a company, or information of the annual income that has been received from the respective users and that are stored in the user skill database 2023, and presents the action to the user. As an example, in a case where there are a large number of created lines in the source code and a large number of pushes of the source code for a certain period of time, but there are a small number of pull requests and a small number of source code reviews of which a notification has been given, it is considered that it is possible to raise the evaluation as a leader or a manager by increasing these values, and to increase the skill parameter of the user. In this case, the career recommendation module 2038 recommends an action for increasing the number of pull requests and the number of source code reviews.

In addition, in the case where the user desires to increase the annual income, if the user is able to make a contribution while participating in a predetermined project, for example, if the user is able to make a certain contribution to a famous project that is attracting attention also from the outside of the project or a project with a high degree of difficulty, it is considered that it is possible to increase the skill parameter, and also to increase the assumed annual income accordingly. Other than this, if the user is able to obtain a certain evaluation from others (irrespective of inside or outside the company), for example, if the user posts a message on an SNS and is able to obtain a so-called “like”, it is considered that it is possible to increase the skill parameter, and also to increase the assumed annual income accordingly. Furthermore, if the user posts a message on the OSS, and is able to obtain a certain evaluation and to make a specific contribution accordingly, it is considered that it is possible to increase the skill parameter, and also to increase the assumed annual income accordingly. Therefore, the career recommendation module 2038 presents the above-described actions to the user.

In addition, in the case where the user desires to increase the annual income, if user gains experience in a different job category, it is considered that it is possible to increase the skill parameter, and also to increase the assumed annual income accordingly. For example, in a case of a user who has only experience as a front-end engineer, if experience as a back-end engineer is added, it is considered that the value as an engineer rises. Therefore, in addition to the job category that has been designated by the user in the user job category reception module 2035, the career recommendation module 2038 receives the designation of a job category in which the user desires to have experience, specifies an assumed annual income including a case where if the user gains the experience in such a job category, and presents the assumed annual income to the user.

Furthermore, regarding the job category that has been designated by the user who desires to have experience, it may be configured such that it is possible to search the recruitment information in the company recruitment database 2022 for such a job category, and to present a search result to the user. Furthermore, it may be configured such that the user is actually able to apply for the recruitment information of the search result, and specifically, an application button (application means) for the recruitment information of the search result is arranged to be presented to the user. When the user presses such an application button, information for giving a notification that the job application has been made may be transmitted for notification to a recruiting staff side of the company together with the information about the user.

Furthermore, regarding the job category that has been designated by the user who desires to have experience, it may be configured such that information of an assumed annual income including a case where if the user gains the experience in such a job category can be posted as a message on the SNS. This is because these days message contents posted on the SNS leads to employment, in some cases. Specifically, it may be configured such that a message post button (message post means) is arranged on a display screen of the assumed annual income, so that the user can post a message on the SNS with the assumed annual income of the user and link information to a screen for receiving designation of a job category in which the user desires to have experience. At this timing, for example, in a case of Twitter (registered trademark), it may be configured to add a predetermined hash tag. This is for the recruiting staff side of the company to be able to recognize it.

<2 Data Structure>

The data structure in the second embodiment is similar to that in the first embodiment, and it will not be described again.

<3 Operation>

The operation in the second embodiment is similar to that in the first embodiment, and it will not be described again.

<4 Screen Example>

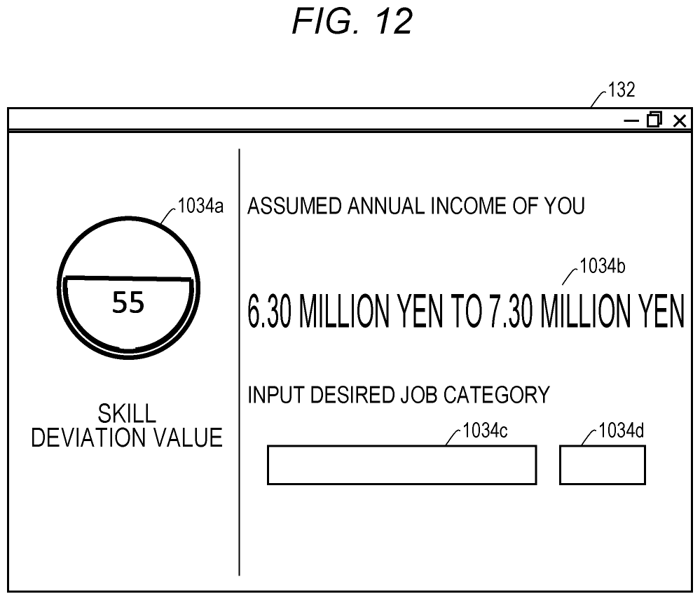

Hereinafter, referring to FIGS. 12 to 15, screen examples of the analysis result and the desired job category input processing by the assumed annual income presentation system 1 will be described.

FIG. 12 is a diagram illustrating a screen example of a skill parameter, an assumed annual income, and a desired job category input field to be displayed on the terminal device 10. The screen example of FIG. 12 illustrates a screen example in a state of displaying a skill parameter, an assumed annual income that has been specified, based on the skill parameter, and an input field for receiving designation of a job category in which the user desires to have experience. This step corresponds to step S314 in FIG. 8.

As illustrated in FIG. 12, in response to a reception of an instruction operation for calculating an assumed annual income from a user, the display 132 of the terminal device 10 displays a skill parameter display field 1034a and an assumed annual income display field 1034b, which are respectively similar to the skill parameter display field 1032a and the assumed annual income display field 1032b illustrated in FIG. 10, and in addition, a desired job category input field 1034c for receiving designation of a job category in which the user desires to have experience and an assumed experience period input field 1034d in such a job category. The user inputs a specific job category name and an experience period (years) in such a job category respectively in the desired job category input field 1034c and the assumed experience period input field 1034d, and gives an instruction for specifying the assumed annual income again. Then, the assumed annual income including a case where if the user gains the experience in the job category that has been input during the period of time that has been input is specified and caused to display in the skill parameter display field 1034a and the assumed annual income display field 1034b. With such a configuration, it becomes possible to assume specific career information for increasing the assumed annual income, and to specify the assumed annual income of the future.

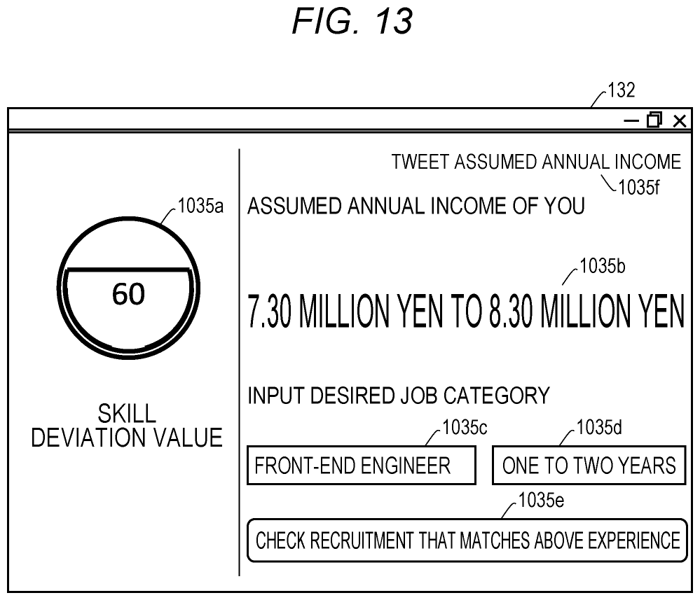

FIG. 13 is a diagram illustrating a screen example of a result to be displayed on the terminal device 10, after the skill parameter, the assumed annual income, and the desired job category are input. The screen example of FIG. 13 illustrates a screen example in a state of displaying the assumed annual income that has been specified again, after inputs have been made in the desired job category input field 1034c and the assumed experience period input field 1034d in the screen example of FIG. 12. This step corresponds to step S314 in FIG. 8.

As illustrated in FIG. 13, after the user makes an input of the desired job category, in response to a reception of an instruction operation for calculating the assumed annual income again from the user, the display 132 of the terminal device 10 displays a skill parameter display field 1035a, an assumed annual income display field 1035b, a desired job category input field 1035c, and an assumed experience period input field 1035d, which are respectively similar to the skill parameter display field 1034a, the assumed annual income display field 1034b, the desired job category input field 1034c, and the assumed experience period input field 1034d illustrated in FIG. 12, and in addition, a recruitment search button 1035e by which the user is able to search for jobs in such a job category, and an SNS message post instruction 1035f. Here, in the skill parameter display field 1035a and the assumed annual income display field 1035b, the skill parameter and the assumed annual income are displayed, in the case where if the user gains experience in the job category for the period of time while the user desires to have experience that have been input by the user into the desired job category input field 1035c and the assumed experience period input field 1035d. As compared with FIG. 12, it can be understood that the skill parameter and the assumed annual income are increased by gaining the experience in the job category that has been input into the desired job category input field 1035c and the assumed experience period input field 1035d. With the assumed annual income display field 1035b, the user is able to grasp the contents of a specific job category that the user should have experience, in the case where the user desires to increase the annual income.

In addition, as illustrated in FIG. 13, the recruitment search button 1035e is arranged on the display 132 of the terminal device 10, so that that user can search recruitment information in the company recruitment database 2022 for the job category that has been designated by the user who desires to have experience. Accordingly, the user is able to actually apply for a specific job category that the user should have experience, in the case where the user desires to increase the annual income. Further, in searching the recruitment information, the recruitment information may be extracted and presented, based on the skill parameter of the user or the career information of the user, so that the recruitment information having a high degree of matching with the user's skills or desired conditions may be presented on a priority basis. For example, the skill parameter of the user may be calculated for every programming language and every software framework, so that recruitment information of the programming language and software framework that the user has a high skill parameter may be extracted on a priority basis. Furthermore, the job categories in the past, years of experience, and self-recommended skills may be acquired as the career information of the user, so that recruitment information that the user has long years of experience may be extracted on a priority basis of the user, or recruitment information including the self-recommended skill of the user may be extracted on a priority basis.

Furthermore, as illustrated in FIG. 13, the SNS message post instruction 1035f is arranged on the display 132 of the terminal device 10, so that the user can post a message on the SNS with information of the assumed annual income including the case where if the user gains the experience in the job category that has been designated by the user who desires to have experience. Accordingly, the user is able to externally make an appeal for a specific job category that the user should have experience, in the case where the user desires to increase the annual income.

Furthermore, information of the user to whom the assumed annual income has been presented may be presented to a company side in response to a user's request. This is for promoting the matching, in a case where the user is actively considering a change of job or the like. However, the information is not presented without the user's request. In this situation, as illustrated in FIG. 12, the assumed annual income corresponding to the current skills and experience at the present time may be presented to the company side. As illustrated in FIG. 13, the assumed annual income including the case where if the user gains experience in the job category that has been designated by the user who desires to have experience may be presented to the company side. By presenting information of a user who is highly willing to change jobs to the company side, it becomes possible to promote the matching.

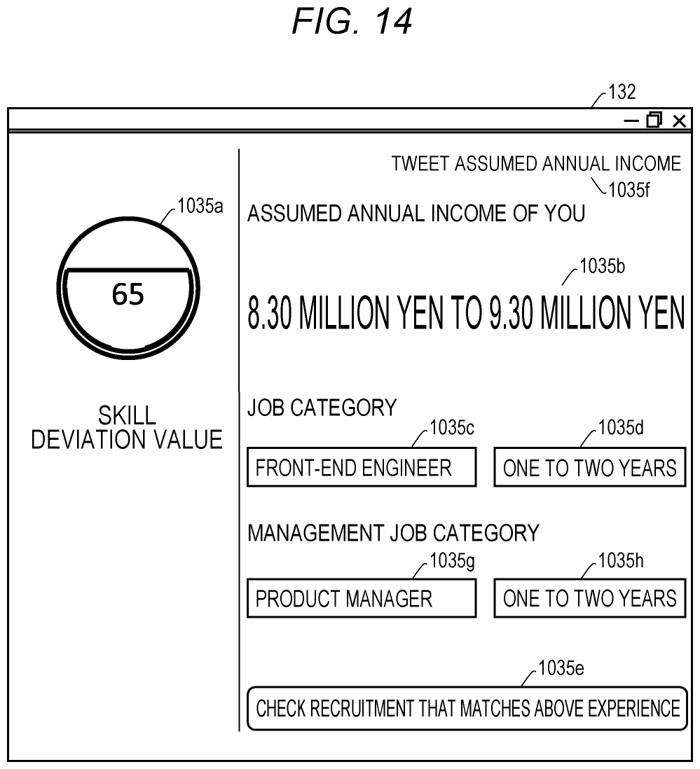

FIG. 14 is a diagram illustrating another screen example of the result to be displayed on the terminal device 10, after the skill parameter, the assumed annual income, and the desired job category are input. In the screen example of FIG. 14, the desired job category input field 1035c and the assumed experience period input field 1035d, which are provided in the screen example of FIG. 13, and in addition, a desired job category input field 1035g and an assumed experience period input field 1035h are provided, and after inputs are made in these fields, a screen example in a state of specifying the assumed annual income again is illustrated. This step corresponds to step S314 in FIG. 8.

As illustrated in FIG. 14, in response to a reception of an instruction operation for calculating the assumed annual income again from the user after the user inputs the desired job category, the display 132 of the terminal device 10 displays the desired job category input field 1035c and the assumed experience period input field 1035d, which are illustrated in FIG. 13, and in addition, the desired job category input field 1035g and the assumed experience period input field 1035h are provided on the same screen. In the example illustrated in FIG. 14, the desired job category input field 1035c and the assumed experience period input field 1035d are configured to receive inputs of experience of technical skills as an engineer, and the desired job category input field 1035g and the assumed experience period input field 1035h are configured to receive inputs, for example, experience of management skills as a higher-level skill of an engineer. For example, an assumed annual income of the user may be specified, based on the skill parameter of the user, weighting may be given in accordance with the job category and the years of experience of the user. When an addition is given to the annual income, weighting based on the experience of the technical skill and weighting based on the experience of the management skill may be added at different values or rates. Specifically, the weighting in accordance with the experience of the management skill may be multiplied and added at a higher rate than the weighting in accordance with the experience of the technical skill.

As illustrated in FIG. 14, by specifying the assumed annual income of the user, based on the technical skill as an engineer and the management skill that is a higher-level skill of the engineer, it becomes possible to encourage the user to take an action for acquiring a career skill different from the technical skill. For example, it becomes possible to compare the assumed annual income obtained by improving the technical skill as an engineer with the assumed annual income obtained by improving the management skill, so that the user can compare and consider a plurality of his/her own career plans. That is, with such a configuration, it becomes possible to encourage the user to take various actions.

In addition, it is configured such that the recruitment search button 1035e illustrated in FIG. 14 is pressed by a user, and recruitment information in the company recruitment database 2022 is searched for a job category in which the user desires to have experience for the technical skill as an engineer and experience for the management skill, so that search results can be referred to on the same screen. Accordingly, regarding a result of comparing and considering his/her own career plans, the user is able to compare and consider actual recruitment information, and is able to actually apply for a job.

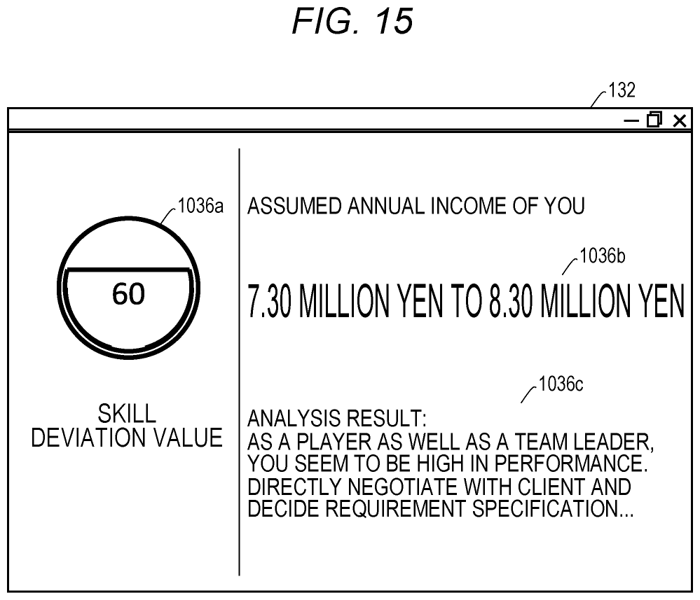

FIG. 15 is a diagram illustrating a screen example of a skill parameter, an assumed annual income, and an analysis result to be displayed on the terminal device 10. The screen example of FIG. 15 illustrates a screen example in a state of displaying a skill parameter, an assumed annual income that has been specified, based on such a skill parameter, and an analysis result in accordance with various parameters on GitHub. This step corresponds to step S314 in FIG. 8.

As illustrated in FIG. 15, the display 132 of the terminal device 10 displays a skill parameter display field 1036a and an assumed annual income display field 1036b, which are similar to the skill parameter display field 1032a and the assumed annual income display field 1032b illustrated in FIG. 10, and in addition, an analysis result display field 1036c for displaying an analysis result in accordance with various parameters on GitHub. With the analysis result display field 1036c, the user is able to grasp a specific action, in the case where the user desires to increase the annual income. As another example of the analysis result to be displayed, it may be indicated that if how many the first parameter is increased, such as the skill parameter, the business score, and the dissemination ability score, how much the assumed annual income is increased. For example, by displaying “If the first parameter increases by oo, the assumed annual income may increase by ΔΔ at maximum” or the like, the user is able to grasp a target value for increasing the annual income.

Note that the job category field and the experience period of the job category, the management job category field and the experience period of the management job category, and the analysis result display field as illustrated in FIGS. 14 and 15 can be added not only to as a mode in the second embodiment but also to a mode in the first embodiment.

<Summary>

As described heretofore, according to the present embodiment, it becomes possible to grasp a skill parameter necessary for obtaining an annual income (increasing the annual income) different from the specified annual income or information of a necessary action, and further to actually start the action. This makes it possible to further encourage the engineer to be active beyond an organization or a team.

Heretofore, the embodiments according to the disclosure have been described. However, they can be implemented in various other aspects, and can be implemented with various omissions, substitutions, and changes. These embodiments, modifications, and omissions, substitutions, and changes are included in the technical scope of the claims and the scope of equivalents thereof.

### Supplementary Note

The matters that have been described in the above embodiments will be supplementally described below.

(Supplementary note 1) A program to be executed by a computer including a processor 29 and a storage unit 202, in which the program causes the processor to execute: a step of acquiring a first parameter for evaluating a skill of a user as an engineer for either or both of a programming language that the user has use experience and a software framework that the user has the use experience (S113); and a step of specifying an assumed income for the user, by using an income prediction model for predicting an income of the user, based on the first parameter of the user (S323).

(Supplementary note 2) A program to be executed by a computer including a processor 29 and a storage unit 202, in which the program causes the processor to execute: a step of acquiring a first parameter for evaluating a skill of a user as an engineer (S113); a step of receiving career information about a career of the user as the engineer (S321); and a step of specifying an assumed income for the user, by using an income prediction model for predicting an income of the user, based on the first parameter of the user and the career information of the user (S323).

(Supplementary note 3) The program described in (Supplementary note 2), in which information of a job category of the user and an experience period of the user in every job category is received as the career information.

(Supplementary note 4) The program described in (Supplementary note 3), in which in a case where a plurality of job categories of the user are received, the assumed income is specified for the user with priority given to a job category of the user having a long experience period.

(Supplementary note 5) The program described in (Supplementary note 3), in which in a case where a plurality of job categories of the user are received, the assumed income is specified for the user with the plurality of job categories of the user in a comprehensive manner.

(Supplementary note 6) The program described in (Supplementary note 2), in which information of a skill that the user possesses is received as the career information.

(Supplementary note 7) The program described in (Supplementary note 2), in which information about the user on an open source that has been recorded on a network is received as the career information.

(Supplementary note 8) The program described in (Supplementary note 2), in which the assumed income is specified for the user, based on the career information of the user related to a higher-level skill as the engineer, as the career information.

(Supplementary note 9) The program described in one of (Supplementary note 1) to (Supplementary note 8), in which the program causes to further execute a step of presenting, to the user, the income that has been specified (S324).

(Supplementary note 10) The program described in one of (Supplementary note 1) to (Supplementary note 9), in which the program causes to further execute a step of specifying the first parameter necessary for the user to obtain an income different from an income to be specified or information about necessary experience in a job category, and presenting to the user (S324).

(Supplementary note 11) The program described in (Supplementary note 10), in which an action (1033c) necessary for raising the first parameter to reach the income different from the income to be specified is specified, and is presented to the user.

(Supplementary note 12) The program described in (Supplementary note 11), in which the action (1033c) necessary for the user is specified, based on an analysis result of information about the user that is recorded on a network (30), and is presented to the user.

(Supplementary note 13) The program described in (Supplementary note 12), in which the program causes to further execute a step of conducting an analysis for the user, based on a second parameter that is recorded on the network (30) and that indicates an achievement of the user as the engineer, and outputting the analysis result (S324).

(Supplementary note 14) The program described in (Supplementary note 11), in which as the action necessary for the user, one or a plurality are specified from the user contributing to a predetermined project as the engineer, the user being evaluated by another person, and the user contributing to predetermined open source software, and are presented to the user.

(Supplementary note 15) The program described in one of (Supplementary note 1) to (Supplementary note 14), in which the storage unit stores recruitment information (2024) of a company, and the program causes to further execute: a step of receiving designation (1033c) of a job category in which the user desires to have experience; and a step of presenting, to the user, the recruitment information of the job category that has been designated by the user who desires to have the experience, based on information stored in the storage unit.

(Supplementary note 16) The program described in (Supplementary note 15), in which designation (1034c) of the job category in which the user desires to have the experience is received on a screen for presenting (1034b), to the user, the income that has been specified, the assumed income including the job category that has been designated by the user who desires to have the experience is presented (1035b), and an operation instruction (1035e) for searching for the recruitment information of the job category that the user has designated that the user desires to have the experience is received.

(Supplementary note 17) The program described in (Supplementary note 15) or (Supplementary note 16), in which as the job category that the user desires to have the experience, either the designation of the job category as the engineer or a job category related to a higher-level skill of the engineer is received on an identical screen.

(Supplementary note 18) The program described in (Supplementary note 17), in which the recruitment information of the job category as the engineer or the job category related to the higher-level skill of the engineer that has been designated by the user who desires to have the experience is presented to the user on the identical screen.

(Supplementary note 19) The program described in one of (Supplementary note 15) to (Supplementary note 18), in which the program causes to further execute: a step of receiving, from the user, an application for the recruitment information that has been presented; and notifying a recruiting side of the recruitment information that has been presented of the application.

(Supplementary note 20) The program described in one of (Supplementary note 1) to (Supplementary note 19), in which the screen that presents, to the user, the income that has been specified includes a posting means (1035f) on an SNS, and the program causes to further execute a step of posting the income that has been specified for the user and link information to a screen that receives designation of the job category in which the user desires to have the experience, based on an operation instruction on the posting means.

(Supplementary note 21) The program described in one of (Supplementary note 1) to (Supplementary note 20), in which the program causes to further execute a step of presenting information of the user to a company side.

(Supplementary note 22) An information processing apparatus including a control unit and a storage unit, in which the control unit executes: a step of acquiring a first parameter for evaluating a skill of a user as an engineer for either or both of a programming language that the user has use experience and a software framework that the user has the use experience; and a step of specifying an assumed income for the user, by using an income prediction model for predicting an income of the user, based on the first parameter of the user.

(Supplementary note 23) An information processing apparatus including a control unit and a storage unit, in which the control unit executes: a step of acquiring a first parameter for evaluating a skill of a user as an engineer; a step of receiving career information about a career of the user as the engineer; and a step of specifying an assumed income for the user, by using an income prediction model for predicting an income of the user, based on the first parameter of the user and the career information of the user.

(Supplementary note 24) A method to be executed by a computer including a processor and a storage unit, in which in the method, the processor executes: a step of acquiring a first parameter for evaluating a skill of a user as an engineer for either or both of a programming language that the user has use experience and a software framework that the user has the use experience; and a step of specifying an assumed income for the user, by using an income prediction model for predicting an income of the user, based on the first parameter of the user.

(Supplementary note 25) A method to be executed by a computer including a processor and a storage unit, in which in the method, the processor executes: a step of acquiring a first parameter for evaluating a skill of a user as an engineer; a step of receiving career information about a career of the user as the engineer; and a step of specifying an assumed income for the user, by using an income prediction model for predicting an income of the user, based on the first parameter of the user and the career information of the user.

1. An electronic device, comprising:
processing circuitry configured to
acquire a first parameter for evaluating a skill of a user as an engineer for either or both of a programming language and a software framework with which the user has use experience; and
specify an assumed income for the user, by using an income prediction model for predicting an income of the user, based on the first parameter of the user.

2. An electronic device, comprising:
processing circuitry configured to
acquire a first parameter for evaluating a skill of a user as an engineer;
receive career information about a career of the user as the engineer; and
specify an assumed income for the user, by using an income prediction model for predicting an income of the user, based on the first parameter of the user and the career information of the user.

3. The electronic device according to claim 2, wherein information of a job category of the user and an experience period of the user in every job category is received as the career information.

4. The electronic device according to claim 3, wherein in a case where a plurality of job categories of the user are received, the assumed income is specified for the user with priority given to a job category of the user having a long experience period.

5. The electronic device according to claim 3, wherein in a case where a plurality of job categories of the user are received, the assumed income is specified for the user with the plurality of job categories of the user in a comprehensive manner.

6. The electronic device according to claim 2, wherein information of a skill that the user possesses is received as the career information.

7. The electronic device according to claim 2, wherein information about the user on an open source that has been recorded on a network is received as the career information.

8. The electronic device according to claim 1, wherein the processing circuitry is further configured to
present, to the user, the income that has been specified.

9. The electronic device according to claim 1, wherein the processing circuitry is further configured to
specify the first parameter necessary for the user to obtain an income different from an income to be specified or information about necessary experience in a job category, and present to the user.

10. The electronic device according to claim 9, wherein an action necessary for raising the first parameter to reach the income different from the income to be specified is specified, and is presented to the user.

11. The electronic device according to claim 10, wherein the action necessary for the user is specified, based on an analysis result of information about the user that is recorded on a network, and is presented to the user.

12. The electronic device according to claim 11, wherein the processing circuitry is further configured to
conduct an analysis for the user, based on a second parameter that is recorded on the network and that indicates an achievement of the user as the engineer, and output the analysis result.

13. The electronic device according to claim 10, wherein as the action necessary for the user, one or a plurality are specified from the user contributing to a predetermined project as the engineer, the user being evaluated by another person, and the user contributing to predetermined open source software, and are presented to the user.

14. The electronic device according to claim 1, wherein
a memory stores recruitment information of a company, and
the processing circuitry is further configured to:
receive designation of a job category in which the user desires to have experience; and
present, to the user, the recruitment information of the job category that has been designated by the user who desires to have the experience, based on information stored in the memory.

15. The electronic device according to claim 14, wherein
designation of the job category in which the user desires to have the experience is received on a screen for presenting, to the user, the income that has been specified,
in response to receiving an instruction operation for calculating an assumed annual income from the user, the assumed income including the job category that has been designated by the user who desires to have the experience is presented, and
an operation instruction for searching for the recruitment information of the job category that has been designated by the user who desires to have the experience is received.

16. The electronic device according to claim 14, wherein
on the screen that presents, to the user, the income that has been specified,
as the job category that the user desires to have the experience, either the designation of the job category as the engineer or a job category related to a higher-level skill of the engineer is received on an identical screen,
in response to receiving an instruction operation for calculating an assumed annual income from the user, the assumed income including the job category as the engineer and the job category related to the higher-level skill of the engineer is presented, and
an operation instruction for searching for the recruitment information of one or both of the job category as the engineer and the job category related to the higher-level skill of the engineer is received.

17. The electronic device according to claim 16, wherein
on the screen that presents, to the user, the income that has been specified,
in response to receiving the operation instruction for searching for the recruitment information from the user, the recruitment information of one or both of the job category as the engineer and the job category related to the higher-level skill of the engineer is presented to the user on the identical screen.

18. The electronic device according to claim 14, wherein the processing circuitry is further configured to:
receive, from the user, an application for the recruitment information that has been presented; and
notify a recruiting side of the recruitment information that has been presented of the application.

19. The electronic device according to claim 1, wherein the screen that presents, to the user, the income that has been specified includes a button configured to post on a social networking service (SNS), and
the processing circuitry is further configured to
post the income that has been specified for the user and link information to a screen that receives designation of the job category in which the user desires to have the experience, in response to a user pressing the button.

20. A non-transitory computer-readable storage medium storing computer readable instructions thereon which, when executed by a computer, cause the computer to perform a method, the method comprising:
acquiring a first parameter for evaluating a skill of a user as an engineer for either or both of a programming language and a software framework with which the user has use experience; and
specifying an assumed income for the user, by using an income prediction model for predicting an income of the user, based on the first parameter of the user.
